(19) United States
(12) Patent Application Publication
(10) Pub. No.: US 2007/0003791 A1
(43) Pub. Date: Jan. 4, 2007

(54) Stone-like laminate

(75) Inventor: Michel Rochette, Ste-Foy (CA)

Correspondence Address: Fronz Bonsang;C/o Protections Equinox Int'l., 224-4480 Cote-de-liesse, Montreal, QC, H4N 2R1, CA

(73) Assignee: SURFACES TECHNIBOARD INC., Lac Beauport (CA)

(21) Appl. No.: 10/568,864

(22) PCT Filed: Aug. 17, 2004
(86) PCT No.: PCT/CA04/01520

§ 371 Date: Feb. 21, 2006

(30) Foreign Application Priority Data
Aug. 28, 2003 (US) 10/604,967
Sep. 11, 2003 (CA) 2,441,494

(51) Int. Cl. B32B 13/00; B05D 3/12; B05D 5/00

(52) U.S. Cl. 428/703; 427/256; 427/180; 427/355

(57) ABSTRACT

The present invention relates to a stone like laminate that comprises a support layer made from a cementious matrix board and a surface layer. The surface layer comprises a high percentage of particles from an inorganic material such as stone particles and a low percentage of a resin, such as a polyester resin. The stone like laminate of the present invention can be produced at low cost and provides a aesthetic laminate that is highly resistant to heat, water and pressure.

### TECHNICAL FIELD

The present invention generally relates to a stone-like laminate comprising a support layer made from a pre-cured cementious matrix board and a surface layer comprising a resin and particles of an inorganic material.

### BACKGROUND ART

Sheets of polished stone, such as marble or granite, have become prestigious material in the manufacture of countertops or decorative panels, especially for their aesthetic characteristics. However, natural stone sheets are very expensive, mainly due to the cost involved in shaping and polishing raw stones. In addition, the raw material is usually obtained from remote regions and therefore, the cost associated with transportation contributes to increase the already elevated cost of stone panels. Other drawbacks associated with natural stone panels include stone imperfections that cause cracking and general fragility of the sheets and staining and bacteria growth in porosities.

In the past years, may attempts were made to develop panel products having the appearance of natural polished stone, while being substantially more affordable and avoiding problems related to heaviness, transportation and installation. These engineered stone products are, for most of them, produced following a so-called “Brenton-Stone” technology, disclosed in U.S. Pat. No. 4,698,010 to Toncelli. Briefly, this technology consists in blending a low percentage of a polyester resin with inorganic particles, such as stone particles to obtain a relatively dry mass of mixed material. The mixed material is then cured to obtain a slab, which becomes rigid after polymerization of the resin material. Such engineered stone products are commercialized under trade names that include Cambria®, CeasarStone®, Silestones®, Technistone® and Zodiaq®.

Several drawback are however associated with these engineered stone panels. For example, to prevent bending of large surface panels and breaking of panels during the polishing process, the slabs must be thick, being most of the time thicker than ¾ inch (2 cm). Therefore, the resulting panels are heavy, difficult to transport and to handle, require very strong panel supporting structures and cannot be stacked onto one another. In fact, typical marketed engineered stone products weigh the same as natural granite, which increases the handling and installation costs.

To reduce the thickness or the weight of the engineered stone material while preserving rigidity and solidity, the prior art discloses lamination of the engineered stone material on a base layer of wood, plastic or metal. When unpolymerized material is poured and cured onto such a layer, shrinkage of polyester resin during polymerization causes a tension over the layer, which responds by forming a convex shape, a characteristic that is not a desirable for a panel.

Other approaches rely on multi-step laminating. Briefly, this process consists in curing the stone like product, removing it from the mold and gluing it on a support layer made from wood, metal or plastic with a special adhesive once it is polymerized. A disadvantage of the multiple step laminating procedure is that the decorative part is very thin and therefore fragile to polish. In addition, the decorative layer being glued to the base layer, small air pocket may be formed between the support and the decorative layer, creating zones that will eventually crack under small impact or a heat source. Delamination of the surface material is also often observed.

Considering the state of the prior art, it would be highly desirable to be provided with a laminate panel having the appearance of natural polished stone, while being light, easy to handle and to transport, producible at low cost and resistant to bending, delamination and heat.

### DISCLOSURE OF THE INVENTION

One object of the present invention is to provide a stone-like laminate comprising a support layer and at least one surface layer disposed over the support layer. The support layer comprises a pre-cured heat-absorbing cementious matrix board and the surface layer comprises at least eighty percent of particles of an inorganic material and at most twenty percent of a resin. The resin is effective to ensure adhesion of the surface layer on the support layer and to cause the surface layer to form an integral structure.

It is also an object of the present invention to provide a stone-like laminate comprising a support layer and at least one surface layer disposed over the support layer, wherein the support layer comprises a perforated, scarified or chemically treated pre-cured heat-absorbing cementious matrix board. The surface layer comprises at least eighty percent of particles of an inorganic material, at most twenty percent of a resin and at least one heat-conducting material in particulate form in an amount effective to enhance transfer of heat from the surface layer to the support layer. The resin of the surface layer is effective to ensure adhesion of the surface layer on the support layer and to cause the surface layer to form an integral structure.

A further object of the present invention is to provide a method for producing a stone-like laminate comprising a support layer and a surface layer disposed over said support layer. This method comprises:

providing a support layer having pores or surface irregularities thereon, and which consists of a heat-absorbing cementious matrix board;

applying a thin layer of a resin on at least one surface of the support layer under conditions to cause it to penetrate into the pores or surface irregularities of the support layer and to form a thin resin layer;

applying a mixture layer comprising at least eighty percent of particles of an inorganic material and at most twenty percent of additional resin on the thin resin layer,

compacting the mixture layer over the support layer;

allowing the resin to polymerize to form the surface layer, and the surface layer to become an integral structure comprising the thin resin layer and the mixture layer.

For the purpose of the present invention, the term “cementious matrix board” is intended to mean any a board, panel or the like made from a cementious material and includes but is not limited to cement boards, fiber cement boards, light concrete boards cement bonded particle board, calcium silicate board, other cement base panel product and the like.

### BRIEF DESCRIPTION OF DRAWINGS

Reference will now be made to the accompanying drawings, showing by way of illustration, a preferred embodiment thereof, and in which:

FIG. 1 is a cross-section view of a stone-like laminate according to one embodiment of the present invention.

FIG. 2a to 2f are cross-section views of stone-like laminates according to other embodiments of the present invention.

### MODES OF CARRYING OUT THE INVENTION

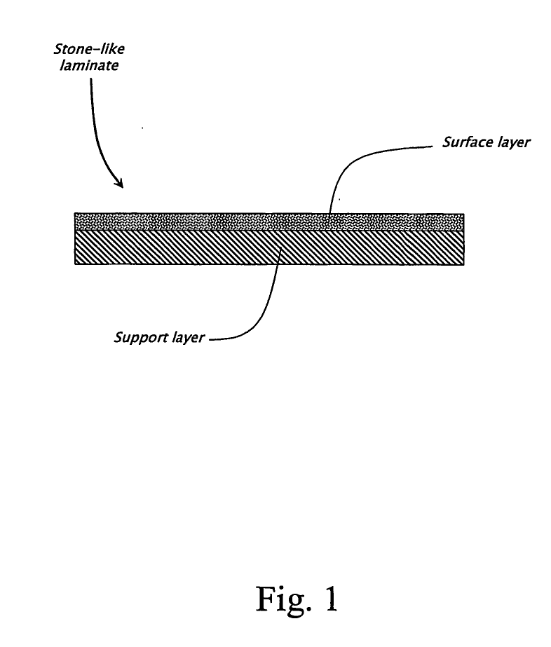

The present invention relates to a stone-like laminate comprising a support layer on which is applied a decorative layer (FIG. 1). The stone like-laminate of the present invention is a panel, a slab or a sheet having predetermined dimensions and designed to be used as kitchen countertops, bathroom vanity tops, shower wall cladding, flooring, table tops or any other decorative panels The stone like-laminate of the present invention can be produced as a slab and further cut according to particular needs. For example, the stone-like laminate of the present invention can be produced in the same dimensions as other engineered stone like products known in the art, such as ¾ inch (2 cm) thick, 10 feet (304.8 cm) long, and 53 inches wide (134 cm). The panel of the present invention is however preferably 10 mm thick including a 6 mm-thick perforated support layer and a 4 mm-thick surface layer. Since the panel of the present invention uses resin and other materials more wisely than other panels known in the art, as it will be described in more details hereinafter, the stone-like laminate of the present invention is significantly lighter than the other known products while maintaining the same strength properties, for predetermined specifications. Since the high cost involved in the production of engineered stone products is largely due to the cost of polymer resins, the present invention proposes a low cost versus strength ratio panel. The strength properties of the stone-like laminate makes it more resistant to bending and pressure and renders possible the use of machinery traditionally used for the processing and polishing of natural or engineered stone products. This step is generally performed with an industrial multi-head polisher, which requires a pressure as high as over 100 metric tons, polishing fluids and heat. The stone-like laminate of the present invention is pressure resistant, highly wet resistant and highly heat resistant, without encountering any deformation or dimensional variation.

Since the stone-like laminate of the present invention is lighter than other products derived from natural or engineered stones, it is easier to handle and to install, and usual carpentry tools can be used to work with. The stone-like laminate of the present invention is also impact resistant, termite and vermin resistant, highly fire-resistant, moisture resistant and it provides very good and economical structural qualities to the final product. In addition, because the stone-like laminate of the present invention requires a smaller amount of petroleum-derived resin or polymeric material than other engineered stone-like panels, the production of the present invention causes less pollution.

Many properties of the present invention are conferred to the stone-like laminate by the support layer That is made of a cementious matrix, a fiber cement, a light concrete or the like, in the form of a board, and is preferably a pre-cured board and even more preferably a heat absorbent-type pre-cured cementious matrix board. The term cementious matrix board, as used in the present invention, should therefore be interpreted broadly rather than restrictively and includes, but is not limited to boards or panels made from a cementious material such as cement boards, fiber cement boards, light concrete boards, cement bonded particle boards, calcium silicate boards, other cement base panel products, or the like. The cemetious matrix board comprises aggregates such as ground silica, amorphous silica, micro silica, diatomaceous earth, coal combustion fly and bottom ashes, rice hull ash, blast furnace slag, granulated slag, steel slag, mineral oxides, mineral hydroxides, clays, magnesite or dolomite, metal oxides and hydroxides, polymeric beads, and mixtures thereof, bound together by a binding agent such as Portland cement, high alumina cement, lime, high phosphate cement, ground granulated blast furnace slag cement, and mixtures thereof. The cementious matrix board may further comprise mica, fiberglass, cellulose fibers, natural fibers, synthetic fibers, calcium silicate, wood material and mixtures thereof. The support layer has a thickness that preferably ranges from 4 to 40 mm.

The nature of the support layer provides the stone-like laminate of the present invention with a good resistance to pressure, heat and water. For example, support layer provides the stone-like panel of the present invention with high heat-resistance, being capable of absorbing heat over 400° F. while avoiding any delamination. In addition, the support layer should agree with the process for the production of the stone-like laminate of the present invention, which implies high pressures (up to 100 tons), heat and humidity. In addition to those physical properties, the cement board provides the stone-like laminate of the present invention with an excellent resistance to delamination. Resistance to delamination is mainly due to the nature of the cementious matrix board. Indeed, the surface layer is bound to the support layer through the polymer resin comprised within the surface layer, as it will be described in more details hereinafter. It is however acknowledged in the art that polyester or acrylic resins have poor adhesion capabilities, which can result in the delamination of the filler resin when it is poured and cured over an inappropriate material such as plastic, wood or some metal substrate. The stone-like laminate of the present invention uses a cementious matrix board as support layer which, contrarily to other materials, has a great porosity and the capacity of heat absorption that significantly contribute to the bonding process with the polymer part. Porous type cementious matrix boards used as a backup layer provide a good receptive layer for polymer resins since the resins penetrate the pores and provide the stone-like laminate with an increased mechanical binding.

The support layer of the present invention can be made integrally of cement, fiber cement or can comprise further elements that enhance its physical properties. For example, the support layer of the present invention may comprise an integrated structure that enhances the strength of the bond created between the cement board or fiber cement board, and the decorative layer. Such integrated structure comprises, but is not limited to, fibers, metals, wood, inorganic particles, fiber grids and metal grids. Alternatively, the support layer can be processed so as to increase adhesion with the decorative layer. Such processing of the support layer includes mechanical perforation or scarification, chemical treatment of the support layer or combinations thereof. Perforation and scarification of the porous fiber cement board will act similarly as a radiator that will take the heat of the decorative layer and will transmit the energy to the ambient air. In addition, perforations, scarifications or any other surface irregularities increase the mechanical bound between the surface layer and the support layer. The cement board may comprise a sealant or any other agent that will increase its waterproofing or a metal or aluminium sheet, grid, structure or the like to increase heat evacuations from the cement board. To minimize post-curing convex bending of the laminate, which is attributable to shrinkage of the decorative layer, the cementious matrix board can be curved so as to obtain a concave shaped board prior to curing the surface layer. Alternatively, agents such as thermoplastics can be added to the cured decorative layer to prevent further shrinkage. Thermoplastics used for that purpose are commonly referred to as low-profile additives (LPAs) and include polymethyl methacrylates, vinyl chloride-vinyl acetate copolymers, polyurethanes and styrene-butadiene. copolymers. The cement board may also be processed to enhance the esthetical properties of the stone like laminate. For example, cementious matrix board can be embossed, engraved, painted or a combination thereof to give an impression of color and depth.

The surface of decorative layer of the present invention serves mainly for aesthetic or decorative purposes since it confers the appearance of a polished stone panel to the laminate of the present invention, while being non-pourous and resistant to stain, heat and scratches. The surface layer of the present invention is preferably 0.7 to 10 mm thick and more preferably 5 mm-thick to prevent the presence of small air pockets and reduces the need of requiring the use of vacuum to obtain resistant stone-like laminate. The surface layer comprises at least eighty percent (80%) of an inorganic material and at most twenty percent (20%) of a resin, but preferably comprises at least ninety percent (90%) of an inorganic material and ten percent (10%) of a resin and more preferably ninety-three percent (93%) of an inorganic material and seven percent (7%) of a resin.

The particles of inorganic material of the decorative layer include any inorganic material in the form of particles. The term particle as used herein is intended to mean any particle, granule, pellet, chip, fragment, grain, crumb or the like from any opaque or transparent inorganic material suitably usable for the purpose of producing the stone-like laminate of the present invention. The inorganic material is however preferably includes a mineral, and more preferably stone, rock, sandstone, limestone, boulder, pebble, calcite, feldspar, glass, marble, mica, obsidian, sand, silica, wollastonite alumina trihydrate, calcium carbonate, silica, alumina trihydrate, antimony oxide, onyx, talc, titanium dioxide, calcined talc, magnetite, siderite, ilmenite, goethite, galena, coal, pyrite, hematite, limonite, biotite, natural granite, anhydrite, chalk, sandstone, or the like, in the form of particles or powder, and more preferably quartz particles. The inorganic material of the present invention may be obtained, for example, by crushing natural stones or minerals to obtain a determined mesh. The inorganic material of the present invention is preferably constituted by particles having a size that ranges between 0.0001 and 20 mm and more preferably by a combination of 6 mesh (1.7-5.6 mm), 10 mesh (0.6-3.35 mm), 24 mesh (0.15-1.18 mm) and 325 mesh (less that 44 microns) inorganic particles. A skilled artisan will understand that in addition to particles of inorganic material, various filled or unfilled pigments or dyes, insoluble chips of polymeric materials such as cellulose, polyethylene, ethylene copolymers, cross linked polyacrylic polymers, polyesters, polypropylenes, cross-linked polyvinyl chlorides, cross-linked acrylic polymers, polyethylene, ethylene copolymers, phenolic resins, urea/formaldehyde resins, colored chips, hydrated alumina, cross-linked polyvinyl chloride and polyesters, polyacetals, pigments, dyes, colored. rocks, colored glass, colored sand, wood products or ceramic particles can be added to the decorative layer to increase its esthetical aspect. The surface layer may further comprise heat-conducting particles adapted for enhancing transfer of heat from the surface layer to the support layer, such as, but not limited to, reflective flakes and metal particles.

The resin that can be used in the context of the present invention includes any resin capable to bind inorganic material particles together, but is preferably a clear, transparent or translucent resin. Such resin includes, but is not limited to polymer resins such as polyesters, acrylics, epoxy, phenols, silicones, urethanes, siloxanes, silanes, and combinations thereof. For example, wide variety of generally clear, transparent or translucent thermosetting polyester resins are known in the art and fall within the scope of the present invention. Such resins include acrylic resins, vinyl ester resins, epoxy resins and the like. For the purpose of the present invention, unsaturated polyester resins are preferred for reasons of cost, availability, clarity and ease of handling. Depending on the nature of raw materials and on how the resin is manufactured, polyester resins can be formulated to meet any one of a wide range of special needs. Polyester resins are obtained by copolymerization of styrene and unsaturated polyester formed by reacting an alpha, beta-unsaturated dicarboxylic acid with glycol. Other unsaturated polyester resins may be obtained by the polycondensation of dicarboxylic acid, such as phthalic acid or isophthalic acid, with dihydric alcohol such as ethylene glycol or propylene glycol.

The stone-like laminate of the present invention is obtained by providing a pre-cured and heat absorbing cement board on which is poured a mixture comprising the resin and the inorganic particle material. The mixture is then compacted onto the cement board, using a pressure ranging preferably from 100 pounds to 100 metric tons over the whole laminate and more preferably a pressure of 3000 pounds per square foot. The compaction step may further comprise vacuum treatment and vibration so that any gas found within the surface layer will be removed and preferably comprises a vibration step of sixty (60) seconds at 3500 vibrations per minute. Further compaction enables the stone-like laminate to cure. The use of a catalyst that will increase the resin polymerization rate during the curing step is also preferred, and more particularly the use of 2% (v/w) catalyst, such as a peroxide catalyst commonly used for the polymerization of unsaturated polyester resins. Since the polymerization rate at room temperature is not optimal, curing at high temperatures is also preferred, especially with a surface layer comprising a polyester resin. Curing temperatures up to 300° F. can be used since the cementious matrix board is heat-resistant, but a hot curing at 176° F. for 30 minutes is preferred. Total curing of the stone-like laminate can be performed for a period ranging from one (1) to twenty-four (24) hours, but is preferably performed for a twenty-four (24) hour period. After polymerization of the resin content, the stone-like laminate is unmolded, gauged and calibrated. For further calibration, the stone-like laminate of the present invention is polished using a standard polisher.

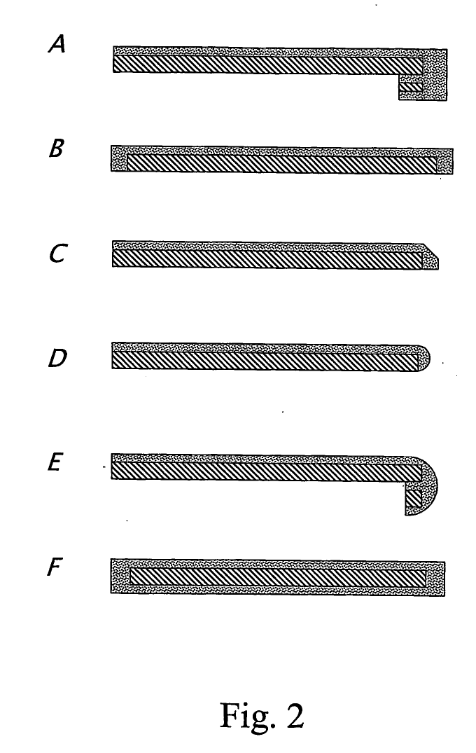

To enhance the binding of the surface layer on the support layer, a thin layer of resin is applied on the cement board prior to pouring the mixture comprising the resin and the inorganic material. The thin resin layer is then allowed to penetrate into the pores or irregularities of the cement board. The mixture is applied over the thin resin layer while the resin of both the mixture and the thin resin layer remains unpolymerized. The mixture and the thin resin layer contact each other and form an integral structure with the inorganic particle material. Since the resin penetrates and polymerizes within the pores or irregularities of the cementious matrix board, it increases the mechanical bound with the surface layer. A skilled artisan will understand that the stone-like laminate of the present invention is not restricted to a structure comprising a surface layer perfectly superposing a support layer. For example, the surface layer of the present invention can cover a surface that is wider or narrower than the support layer. Additionally, a skilled artisan will understand that the surface layer, although generally planar, may comprise a lip that covers at least one side face of the support layer, as illustrated in FIG. 2a to FIG. 2e, which constitute an embodiment of the present invention. Alternatively, the surface layer may cover two faces or the entirety of the support layer (FIG. 2f). The laminate of the present invention can also comprise tongue and groove structures on the lateral sides of the panel so that multiple stone-like laminate panels can be fitted into one another.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows with the scope of the appended claims.

1. A stone-like laminate comprising a support layer and at least one surface layer disposed over said support layer, said support layer comprising a pre-cured heat-absorbing cementious matrix board, said surface layer comprising at least eighty percent particles of an inorganic material and at most twenty percent of a resin, said resin being effective to ensure adhesion of said surface layer on said support layer and to cause said surface layer to form an integral structure.

2. Stone-like laminate according to claim 1, wherein said support layer is a perforated, scarified or chemically treated pre-cured heat-absorbing cement board.

3. Stone-like laminate according to claim 1, wherein said surface layer further comprises heat-conducting particles adapted for enhancing transfer of heat from said surface layer to said support layer.

4. Stone-like laminate according to claim 1, wherein said surface layer has a thickness ranging from 0.7 to 10 mm and wherein said support layer has a thickness ranging between 4 and 40 mm.

5. A stone-like laminate comprising a support layer and at least one surface layer disposed over said support layer, wherein said support layer comprises a perforated, scarified or chemically treated pre-cured heat-absorbing cementious matrix board, wherein said surface layer comprises at least eighty percent of particles of an inorganic material, at most twenty percent of a resin and at least one heat-conducting material in particulate form in an amount effective to enhance transfer of heat from said surface layer to said support layer, wherein said resin is effective to ensure adhesion of said surface layer on said support layer and to cause said surface layer to form an integral structure.

6. Stone-like laminate according to claim 5, wherein said surface layer has a thickness ranging from 0.7 to 10 mm and wherein said support layer has a thickness ranging between 4 and 25 mm.

7. A method for producing a stone-like laminate comprising a support layer and a surface layer disposed over said support layer, which comprises:
providing a support layer having pores or surface irregularities thereon, said support layer comprising a heat-absorbing cementious matrix board;
applying a thin layer of a resin on at least one surface of said support layer under conditions to cause said resin to penetrate into the pores or surface irregularities of said support layer and to form a thin resin layer;
applying a mixture layer comprising at least eighty percent of particles of an inorganic material and at most twenty percent of additional said resin on said thin resin layer;
compacting said mixture layer over said support layer;
allowing said resin to polymerize to form said surface layer, and said surface layer to become an integral structure comprising said thin resin layer and said mixture layer,

8. Method according to claim 7, wherein said support layer is a perforated, scarified or chemically treated pre-cured heat-absorbing cementious matrix board.

9. Method according to claim 7, which comprises forming said surface layer with a thickness ranging from 0.7 to 10 mm and wherein said support layer has a thickness ranging between 4 and 40 mm.

10. Method according to claim 7, wherein said mixture layer further comprises heat-conducting particles adapted for enhancing the transfer of heat from said surface layer to said support layer.
